(19) United States
(12) Patent Application Publication
(10) Pub. No.: US 2003/0123487 A1
(43) Pub. Date: Jul. 3, 2003

(54) SHDSL over POTS

(76) Inventors: Steven R. Blackwell, Huntsville, AL (US); Farrokh Rashid-Farrokhi, Pleasanton, CA (US); Cynthia Lin, Madison, AL (US)

Correspondence Address: FENWICK & WEST LLP, SILICON VALLEY CENTER, 801 CALIFORNIA STREET, MOUNTAIN VIEW, CA, 94041, US

(21) Appl. No.: 10/187,263

(22) Filed: Jun. 28, 2002

Related U.S. Application Data
(60) Provisional application No. 60/317,518, filed on Sep. 5, 2001.

(51) Int. Cl. H04J 1/00

(52) U.S. Cl. 370/485

(57) ABSTRACT

Techniques that allow SHDSL-based systems to share the same transmission line with low frequency voice services such as POTS are disclosed.

### RELATED APPLICATIONS

This application claims the benefit of U.S. Provisional Application No. 60/317,518, filed Sep. 5, 2001, which is herein incorporated in its entirety by reference.

### FIELD OF THE INVENTION

The invention relates to telecommunications, and more particularly, to techniques that allow SHDSL-based systems to share the same line with a voice service.

### BACKGROUND OF THE INVENTION

The Telecommunications Standards Section of the International Telecommunication Union (ITU-T) develops recommendations to facilitate the interoperation of telecommunication networks. One of these recommendations is designated G.991.2. Recommendation G.991.2 describes a digital subscriber line (DSL) standard referred to as G.SHDSL (symmetric high-bit-rate DSL). G.SHDSL is a baseband service, so it is defined to use the spectral region from near 0 Hz to fs/2, where fs is the symbol rate. A typical symbol rate ranges from about 66.67 ksymbols/sec to about 773.3 ksymbols/sec.

The G.SHDSL recommendation makes no provision for analog plain old telephone service (POTS) on the same link that carries the SHDSL data. Rather, G.SHDSL was intended for use in applications that do not require POTS, such as small to medium businesses or home offices. In many cases, these applications use technologies such as channelized or packetized voice over the link rather than traditional POTS. Examples of such technologies include T1/T3, Voice over DSL, and Voice over ATM.

However, these applications are associated with various disadvantages. For instance, lifeline service is generally not available during a power outage at the remote site. In addition, such applications fail to exploit the pricing benefit that may be reaped courtesy of FCC line sharing regulations in certain cases.

What is needed, therefore, are techniques that allow SHDSL services to share the same line with voice services.

### BRIEF SUMMARY OF THE INVENTION

Techniques that allow an SHDSL-based service to share the same line with a voice service, such as POTS are disclosed. A splitter (e.g., non-distributed or distributed type) that can be used to separate the SHDSL data from the voice data may have a negative impact on the useable SHDSL band. Coding techniques are used to reduce this impact thereby enabling a robust and reliable SHDSL over voice solution.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIGS. 1a and 1b are block diagrams each illustrating an SHDSL over voice communication system in accordance with embodiments of the present invention.

FIG. 2 is a block diagram of an SHDSL transceiver configured to operate in a startup mode in accordance with an embodiment of the present invention.

FIG. 3 is a block diagram of an SHDSL transceiver configured to operate in a data mode in accordance with an embodiment of the present invention.

### DETAILED DESCRIPTION OF THE INVENTION

SHDSL systems, by virtue of their required support for coding and adaptive filtering, can be configured to function on loops that do not provide access to the low end of the link's spectral band (e.g., DC to 10 kHz). Given this configurable quality, a SHDSL system can be further modified to allow for integration of a low frequency voice service, such as POTS.

As part of this integration process, a mechanism for separating and combining the two data types can be added to the system at both the central office and the customer's premises. In particular, the mechanism separates the low frequency voice data (e.g., POTS data) from the higher frequency SHDSL data in the receive direction, and also couples the low frequency voice data and the higher frequency SHDSL data on to the line in the transmit direction.

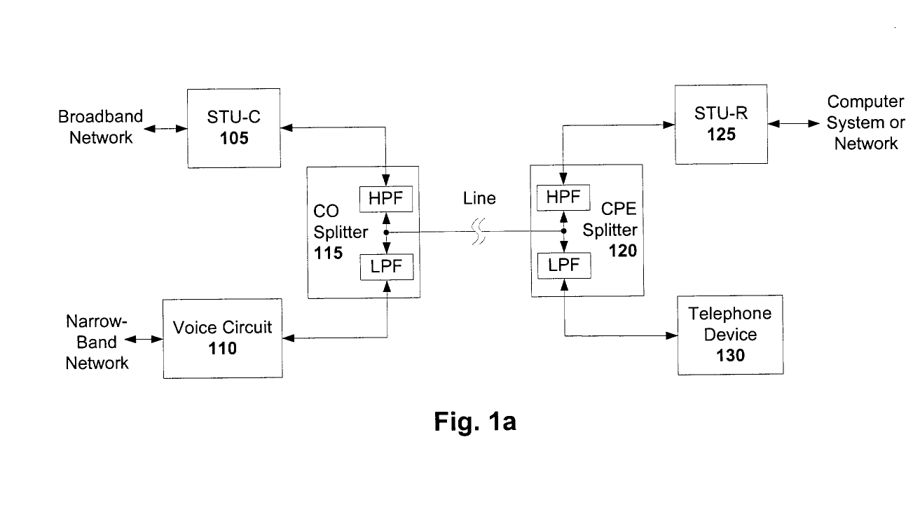

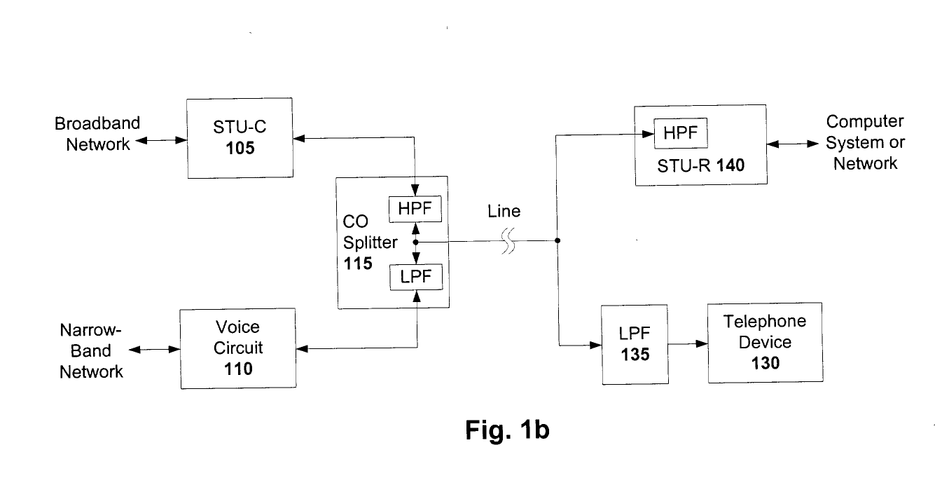

One way to implement this mechanism for separating and combining is to deploy splitters, such as those used in asymmetric DSL (ADSL) systems where the ADSL service and POTS are communicated over the same line. An example splitter based SHDSL system is illustrated in FIG. 1a. Similarly, just as ADSL can coexist with POTS in a distributed splitter environment, an SHDSL system can be configured to do the same thing with appropriate transmit and receive filtering. An example distributed splitter SHDSL system is illustrated in FIG. 1b. The principles of the present invention can be used with other splitter technology as well, such as that described in U.S. patent application Ser. Nos. 09/570,804, “Central Office Interface Techniques,” and 10/138,197, “Splitterless, Transformerless, Voice Service Independent ADSL Interface.” Both of these applications are herein incorporated by reference.

In addition to integrating splitter technology, several modifications can be made to SHDSL devices to significantly improve their operation over a voice service as will be discussed herein.

Splitter Configuration

FIG. 1a illustrates a block diagram illustrating an SHDSL over voice communication system in accordance with an embodiment of the present invention. This embodiment employs a splitter scheme that is used to separate high frequency SHDSL data and low frequency voice data. The system includes a central office SHDSL transceiver (STU-C) 105, an analog voice circuit 110, a central office (CO) splitter 115, a customer premises equipment (CPE) splitter 120, a customer's SHDSL transceiver (STU-R) 125, and a telephone device 130.

The system allows for SHDSL service and a voice service (e.g., POTS) to be provided over the same line. The line is associated with a spectral range. For example, the line may be a copper twisted pair having a usable spectral range of up to 2 MHz for a given distance of communication. Other line types may be used here as well, such as fiber optic cable or coaxial cable. The voice service operates in the low frequency portion of the spectral range, while the SHDSL can operate in the higher frequency portion.

In one embodiment, for example, the voice service is POTS, which operates in the range of about 200 Hz to 4 kHz, and the SHDSL operates in the range above 10 kHz. Other frequency schemes will be apparent in light of this disclosure. In the receive direction, the splitters 115 and 120 separate the incoming signals so that the low and high frequency band signals can be routed to their corresponding destinations. In the transmit direction, the splitters 115 and 120 operate to couple the outgoing signals onto the line in their respective frequency bands. The combined signal can then be communicated to a remote location.

In the downstream direction, higher frequency data is received from a broadband network, such as an ATM network, a broadband ISDN, an IP network, or a TDM network of a T-carrier system (e.g., T1/DS1 or T3/DS3). Such data is received and processed by the STU-C 105 and provided to the line via the high pass filter (HPF) of the splitter 115. Likewise, lower frequency data is received from a narrow-band network, such as a GSTN, narrow-band ISDN, or PCM highway. This data is received and processed by the voice circuit 110, which can be for example, a POTS line card or other voice service circuit. The processed data is then provided to the line via the low pass filter (LPF) of the splitter 115.

In the upstream direction, higher frequency data can be received from the likes of a home network or computer. Such data is received and processed by the STU-R 125 and provided to the line via the high pass filter of the splitter 120. Likewise, lower frequency data is received from the telephone device 130, which can be for example, a telephone set, a voiceband modem, a fax machine, an ISDN terminal, or other voice device or circuit. The data is then provided to the line via the low pass filter of the splitter 120.

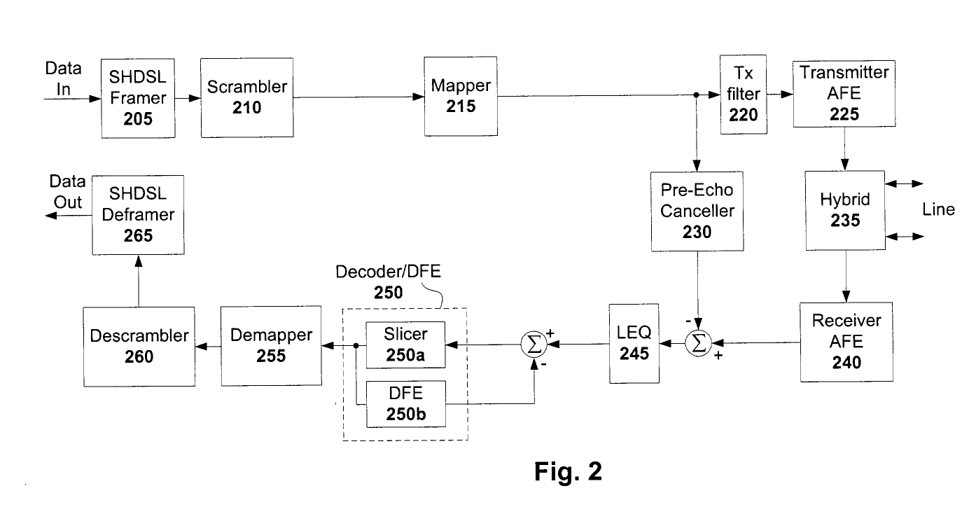

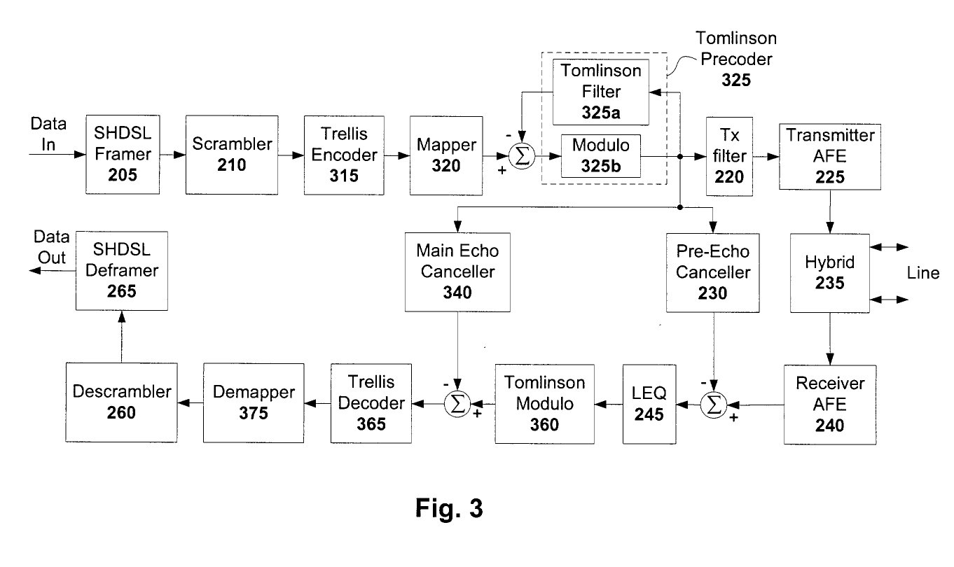

The splitters 115 and 120, as well as the voice circuit/devices 110 and 130 can be implemented in conventional technology. The architecture and functionality of the transceivers 105 and 125 will be discussed in more detail with reference to FIGS. 2 and 3. Additional components, such as repeaters and interfaces, may also be included in the system.

Spreading the Bandwidth in Splitter Applications

The performance penalty for using a SHDSL device in a splitter configuration can be significant for low data rates (e.g., in the kbit/s range). At the higher data rates (e.g., in the Mbit/s range), however, the performance degradation is minimal. This is because the voice bandwidth is constant, while the bandwidth of SHDSL varies with data rate.

In one embodiment, the transceivers 105 and 125 of the system each employ a transformer that cuts off at around 5 kHz (±500 Hz). A splitter used in ADSL systems typically notches out the lowest 10 kHz or so of the link's spectrum. This allows for capture of data in the voice band (e.g., up to about 4 kHz), and further provides a guard band (e.g., from about 4 kHz to 10 kHz) that allows for a desirable degree of roll-off to occur due to the splitter's low pass filter. Thus, the splitters 115 and 120 add an additional 5 kHz of non-usable bandwidth to the SHDSL over voice system in this particular embodiment.

In one embodiment of the present invention, a G.SHDSL signal is approximately 385 kHz wide at 2.320 Mbit/s (e.g., high SHDSL rate). Thus, deploying a splitter only removes an additional 1.3% (5 kHz/385 kHz) of the usable SHDSL band. At 200 kbit/s (e.g., low SHDSL rate), the G.SHDSL signal is approximately 33.33 kHz wide. Here, the 5 kHz of additional non-usable frequency is proportionally much larger. A splitter removes about 15% of the of the usable SHDSL band, so the effect on performance is more significant. For lower data rates (e.g., 384 kHz and below), this negative effect of splitters 115 and 120 can be made less significant by coding fewer bits per symbol, thereby effectively spreading the bandwidth of the signal.

To further explain, the G.SHDSL recommendation calls for the use of 16 TC-PAM (16 level Trellis coded pulse amplitude modulation) at all data rates, which means that the symbol rate is always ⅓ the data rate (3 data bits and a Trellis bit per symbol). To combat the effect of the splitters 115 and 120 on the usable SHDSL band, a lower level of TC-PAM can be used. For instance, 4 TC-PAM or 8 TC-PAM can be used instead of 16 TC-PAM thereby spreading the signal spectrum and limiting the effect of filtering out the low frequency content of the usable SHDSL band performed by the splitters 115 and 120. With 8 TC-PAM, the symbol rate is ½ the data rate, and with 4 TC-PAM, the symbol rate is the same as the data rate. In this sense, the symbol rate increases in relation to the data rate.

This spreading may increase crosstalk from SHDSL into other services, but for low data rates, the performance impact is generally negligible. For example, 4 TC-PAM (1 data bit and a Trellis bit per symbol) can be used for data rates up to 256 kbps, and 8 TC-PAM (2 data bits and a Trellis bit per symbol) can be used for rates between 256 kbps and 512 kbps. Other data rate breakpoints will be apparent in light of this disclosure and depend on factors such as the signal bandwidth, attenuation caused by the communication channel, and channel noise.

Distributed Splitter Configuration

FIG. 1b illustrates a block diagram illustrating an SHDSL over voice communication system in accordance with another embodiment of the present invention. This embodiment employs a distributed splitter scheme (sometimes referred to as splitterless or G.Lite). Like the system illustrated in FIG. 1a, this system includes an STU-C 105, an analog voice circuit 110, and a CO splitter 115. The customer premises equipment, however, is configured differently. In particular, the components of the splitter are distributed, where the high pass filter is integrated in the STU-R 140 and the low pass filter 135 is serially coupled to the data path connecting to the telephone device 130. Variations on this configuration where the low and high pass filters are spatially distant from one another are possible. For example, the low pass filter 135 can be integrated into the telephone device 130. Likewise, the high pass filter can be serially coupled to the data path connecting to the STU-R 140.

In operation, the high pass filter of the STU-R 140 effectively removes low frequency signals (e.g., voice band signals) from the high frequency signal data path between the line and the computer or network. Likewise, the low pass filter 135 effectively removes high frequency signals (e.g., SHDSL band signals) from the low frequency signal data path between the line and the telephone device 130. Thus, the splitting effect of splitter discussed in reference to FIG. 1a is achieved. However, there are additional considerations in a distributed splitter configuration as will now be discussed.

Fast Retrain in Distributed Splitter Applications

In distributed splitter applications, ringing voltage and on-hook/off-hook changes may dramatically alter the characteristics of the loop and the available data rates. Such changes generally disrupt the communication link. The impact of the disruption, however, can be minimized. For example, a fast retrain algorithm based on learned profiles that correspond to the various loop conditions can be implemented by the transceiver pair of STU-C 105 and STU-R 140. In one embodiment, the algorithm is modeled after the fast retrain algorithm as described in the ITU-T recommendation G.992.2, which is included in application Ser. No. 60/317,518. Other fast retrain algorithms can also be implemented here.

Transceiver Architecture

SHDSL transceivers are associated with various modes of operation including data mode, an activation mode and a preactivation mode. The data mode operates after activation procedures have been completed, and allows payload to be communicated between the communicatively coupled transceivers. The activation mode operates before the data mode is entered, and generally establishes a communication link with required transmission parameters between the physically connected and powered transceivers. The activation mode can also be used to modify transmission parameters of the communication link.

The preactivation mode operates before the activation mode is entered, and generally includes one or more handshake sessions and line probing (“training”) sequences. Handshake sessions (e.g., as defined in ITU-T recommendation G.994.1) provide a mechanism for exchanging capabilities and negotiating the operational parameters such as data rate and framing parameters for each transceiver. Line probe sequences provide a mechanism to identify or otherwise derive characteristics of the transmission medium, such as achievable SNR.

The active components of a transceiver depend on the mode in which the transceiver is operating. FIGS. 2 and 3 discuss startup mode (activation and preactivation modes) and data mode architectures. Additional background information is provided in the G.SHDSL recommendation, which is included in application Ser. No. 60/317,518.

Startup Mode

FIG. 2 is a block diagram of an SHDSL transceiver configured to operate in a startup mode in accordance with an embodiment of the present invention. The transceiver includes a transmit section and a receive section coupled to one another via a pre-echo canceller 230 and a hybrid 235. The transmit section includes an SHDSL framer 205, a scrambler 210, a mapper 215, a transmit filter 220, and a transmitter analog front end (AFE) 225. The receive section includes an SHDSL deframer 265, a descrambler 260, a demapper 255, a decoder 250, a linear equalizer (LEQ) 245, and a receiver AFE 240.

During startup mode, training sequence data is received by framer 205 from a data source, such as a computer application or a host network. In one embodiment, the framer 205 frames the received data into the SHDSL frame structure as defined in the G.SHDSL recommendation. Overhead data may also be included in the frame (e.g., embedded operations channel). The framed data is then scrambled by scrambler 210 so as to randomize the data to ensure a robust transmission. The scrambler may employ, for example, a preactivation scrambler polynomial as defined in the G.SHDSL recommendation.

The mapper 215 converts the bit stream from the scrambler 210 to the appropriate output levels. During startup mode, an uncoded 2-PAM scheme can be used to simplify the mapping process. Thus, logical ones and zeros of the scrambler output are mapped into respective one bit symbols. The transmit (Tx) filter 220 shapes and filters the symbol sequence output by the mapper 215 thereby producing a continuous time signal and reducing out-of-band signal components. The Tx filter 220 output is applied to the transmitter AFE 225. In one embodiment, the Tx filter 220 is 49 taps in length for symmetric power spectral densities (PSDs), and is variable in length for the asymmetric PSDs.

The transmitter AFE 225 includes a digital to analog converter for converting the digital signal to its analog equivalent, and a line driver for driving the signal on to the line via the hybrid 235. The transmitter AFE 225 may further include an interpolator to perform interpolation prior to the digital to analog conversion. Hybrid 235 performs 2-to-4-wire conversion, which converts the bi-directional two-wire signal from the line into two pairs of one-directional transmissions. One pair is for receiving and the other pair is for transmitting. The hybrid may also include a DSL coupling transformer, although transformerless configurations are also possible.

Impedance mismatches between the hybrid 235 and the line typically cause a portion of the transmitted signal power to be reflected back to the receiver. The pre-echo canceller 230 is an adaptive transversal filter that learns the response of the hybrid 235 and generates a replica of the reflected signal to be subtracted from the received waveform. In one embodiment, the pre-echo canceller 230 includes two components: an adaptive FIR section and an adaptive IIR section.

The receiver AFE 240 includes an analog to digital converter for converting the analog signal received from the line to its analog equivalent. The receiver AFE 240 may further include a gain adjust module for optimizing signals sent to the LEQ 245. In addition, the receiver AFE 240 may further include a decimator to perform decimation after the analog to digital conversion as a complement to interpolation performed at the transmitting node. The digital signal is provided to a summing junction where the replica of any reflected signal is subtracted out.

The LEQ 245 and the Decoder/DFE 250 operate to reverse inter-symbol interference caused by the transmission channel. The LEQ 245 is a feed forward filter and provides signal reshaping to complement the shaping performed by the Tx filter 220 at the transmitting node. In the embodiment illustrated, the decoder is a level slicer 250a. The decision feedback equalizer (DFE) 250b, which operates only during training mode, is a feedback filter. It is complimentary to a Tomlinson Precoder included in the data mode architecture. In one embodiment, the DFE 250b has 180 taps with 22 bit coefficients.

The decoded and equalized data is provided to the demapper 255, which converts the received PAM levels of the symbols to binary bits. The output of the demapper 255 is provided to the descrambler 260, which provides descrambling to complement the scrambling performed by the scrambler 205 at the transmitting node. Likewise, the output of the descrambler 260 is provided to the SHDSL deframer 265, which deframes the received training sequence to that it can be provided to the local host interface (e.g., network or computer system).

Once the training phase is complete, the activation phase of the link begins, where the receiving node transmits the learned configuration parameters to the transmitting node. The configuration parameters include, for example, precoder coefficients determined by the DFE 250b and the encoder parameters that the receiver expects the transmitting node to use. The transceiver at each node of the SHDSL span can then transition to the data mode.

Data Mode

FIG. 3 is a block diagram of an SHDSL transceiver configured to operate in data mode in accordance with an embodiment of the present invention. The transceiver includes a transmit section and a receive section coupled to one another via a main echo canceller 340 and a hybrid 235. The transmit section includes an SHDSL framer 205, a scrambler 210, a Trellis encoder 315, a mapper 320, a Tomlinson precoder 325, a Tx filter 220, and a transmitter AFE 225. The receive section includes an SHDSL deframer 265, a descrambler 260, a demapper 375, a Tomlinson modulo 360, a Trellis decoder 365, an LEQ 245, and a receiver AFE 240.

Generally, the SHDSL framer 205 and deframer 265 modules, the scrambler 210 and descrambler 260 modules, the Tx filter 220 and the LEQ 245 modules, the transmitter AFE 225 and receiver AFE 240, and the hybrid 235 operate similarly to their operation in startup mode. Note, however, that variations in performance may exist. For example, the polynomial used by the scrambler 210 and descrambler 260 in data mode may be different from that used in startup mode. In addition, the data that is framed/deframed by the SHDSL framer 205 and deframer 260 is user or payload data (as opposed to training sequences), and additional overhead required to support the transport of that payload data may also be included in the framing/deframing process. Other functional differences will be apparent in light of this disclosure.

The Trellis encoder 315 converts the scrambled bit stream to a sequence of K-bit parallel words. The number of bits per parallel word, K, depends on the target data rate in accordance with the principles of the present invention. The least significant bit of each word is then encoded using a convolutional encoding algorithm running in the encoder 315, while bits later in time pass through the encoder 315. The convolutional encoding algorithm generates two bits for each significant bit it encodes, thereby adding an extra Trellis bit to each word. The total number of bits in each word output by the encoder 315, therefore, is K+1. Other coding schemes can be used here as well to ensure a robust transmission and reception.

In one embodiment, the Trellis encoder 315 is programmed or otherwise configured to generate K-bit words, where K equals 3 for target data rates above 512 kbps, K equals 2 for target data rates between 256 kbps and 512 kbps, and K equals 1 for target data rates under 256 kbps. In this sense, the value of K decreases in value with increasing data rates. Alternative embodiments can use other values of K, as well as other data rate breakpoints to achieve a beneficial spreading of the signal spectrum so as to limit the effect of filtering out the low frequency content caused by a splitter. The mapper 320 receives the K+1-bit words generated by the encoder 315, and maps each of the words to a corresponding one of the 2^{K+1} levels of a signal constellation. The resulting transmit signal is provided to the precoder 325.

Tomlinson Shaping

Communication channels generally distort the transmitted signal due to the likes of inter-symbol interference and channel frequency response. A DFE is typically used in receivers to counteract this distortion. A problem associated with using a DFE, however, is error propagation, where decision errors are placed in the feedback part of the equalizer thereby debilitating the equalizer. To prevent this, a Tomlinson precoder can be employed. In the embodiment illustrated in FIG. 3, the Tomlinson precoder 325 includes a feedback filter 325a and a modulo 325b.

The Tomlinson precoder 325 performs the feedback equalization done by the DFE during the startup mode. By performing this feedback equalization in the transmitter, decision errors caused by the channel are not propagated through the feedback filter 325a. The modulo operation 325b is performed in the Tomlinson precoder feedback loop to ensure that the transmitted signal stays within an acceptable spectral range.

An additional technique that may be used to advantage in an SHDSL over POTS configuration is the introduction of spectral shaping through modification of the modulo operator 325b in the Tomlinson precoder 325. In particular, the low frequency spectrum may be shaped by modifying the Tomlinson modulo to force transmit symbol values out of the normal constellation range into an upper or lower copy of the constellation when this approach lowers power near DC. Spectral content can be significantly decreased (e.g., up to 10 dB or more) in the low frequency end of the spectrum using this approach.

In effect, the use of such spectral shaping through the Tomlinson precoder 325 moves the transmit signal's frequency content toward the upper end of the available PSD range. Since the low end of the PSD range is most affected by the introduction of voice service filtering (e.g., FIGS. 1a and 1b), this spectral reallocation or “shaping” can improve performance in an SHDSL over POTS or other voice applications. Another advantage of spectral shaping using the Tomlinson modulo operator 325b is that it is transparent to the receiver, due to the receiver's own complementary Tomlinson modulo operator 360.

The output of the precoder 325 is provided to the Tx filter 220 which performs any necessary spectral shaping. The shaped signal is processed by the AFE 225 (e.g., interpolation and digital to analog conversion) and the resulting signal is applied to the transmission line via hybrid 235. At the receiving node, the transmitted signal is decoupled from the line by a hybrid 235 and provided to the AFE 240 for processing (e.g., analog to digital conversion and decimation). The LEQ 245 operates to reshape the received signal as a complement the shaping performed by the Tx filter 220 at the transmitting node.

In one embodiment, the main echo canceller 340, which is coupled to a summing junction on the output of the Tomlinson modulo operator 360, is trained after the pre-echo canceller 230 and the LEQ 245 are trained. From that point in the training sequence, the main echo canceller 340 provides a more precise echo cancellation during data mode. In such an embodiment, the pre-echo canceller 230 may remain fixed during data mode or may be adapted at a very slow rate. Alternative embodiments may not include the main echo canceller 340. In such embodiments, the echo cancellation can be carried out by the pre-echo canceller 230. Other echo cancellation schemes can be employed here as well.

A complementary Tomlinson modulo operation 360 recovers the original symbols from the expanded symbol set produced by the Tomlinson precoder 325 at the transmitting node. The Trellis decoder 365 converts a sequence of K-bit parallel words associated with the recovered symbols to a bit stream. More specifically, the decoder 365 decides which bit patterns encoded at the transmitting node are the closest to the received bit patterns. Recall that the value of K decreases with increasing data rates so as to limit effects caused by the splitter on usable SHDSL band. Note that the actual structure of Trellis decoder 365 may vary depending on the encoding scheme used at the transmitting node. In one embodiment, a Viterbi decoder is used for Trellis decoder 365 to improve the reliability of the decision.

The demapper 255 then converts the decoded symbols back to a bit stream from which the received data can be extracted. Descrambler 260 and SHDSL deframer 265 then descramble and deframe, respectively, the received data so that it can be provided to the local host (e.g., network operator or computer application).

Note that the components of a transceiver can be implemented in hardware, software, firmware, or any combination thereof. For instance, the encoder/decoder, mapper/demapper, and precoder/modulo modules can all be implemented as a set of instructions executing on a digital signal processor or other suitable processing environment. Alternatively, these modules can be implemented in purpose-built silicon as a chip or chip set. Likewise, the components or a: sub-set of the components can be implemented as an apparatus or device (e.g., transceiver-on-a-chip or modem line card). Alternatively, these modules can be can be incorporated into an apparatus such as a computer program product embodied on a computer readable medium, such as a server or disk.

Further note that other components may also be included in the transceiver architecture, such as a transmission convergence layer (TC) framer that can be used to interface the SHDSL framer 205 and deframer 260 modules with the data source, such as a Utopia or TDM network. Likewise, a noise predictor module can be included that operates during training to whiten noise anticipated in the update path of the LEQ 245, DFE 250b, and the main echo canceller 340.

The foregoing description of the embodiments of the invention has been presented for the purposes of illustration and description. It is not intended to be exhaustive or to limit the invention to the precise form disclosed. Many modifications and variations are possible in light of this disclosure. For example, it will be apparent from this disclosure that the present invention is not intended to be limited to POTS, but can be applied to other voice services such as Special Services or Foreign Exchange Subscriber. Numerous such voice processing applications and corresponding voice circuitry can be combined with SHDSL in accordance with the principles of the present invention. It is intended that the scope of the invention be limited not by this detailed description, but rather by the claims appended hereto.

What is claimed is:

1. An SHDSL over voice communication system comprising:
a splitter including a high frequency filter for filtering SHDSL data and a low frequency filter for filtering voice data, wherein the filters of the splitter can be operatively coupled with an SHDSL over voice transmission line;
a voice circuit operatively coupled to the low pass filter of the splitter, the voice circuit adapted to process voice data received from an SHDSL over voice transmission line; and
an SHDSL transceiver operatively coupled to the high pass filter of the splitter, the transceiver adapted to process SHDSL data received from an SHDSL over voice transmission line, and to operate at a symbol rate that increases in relation to the data rate.

2. The system of claim 1 wherein the system is associated with a PSD range having upper and lower ends, and the SHDSL transceiver includes a Tomlinson precoder having a modulo operator configured to move a transmit signal's frequency content toward the upper end of the PSD range.

3. The system of claim 1 wherein for data rates up to a first data rate breakpoint, the symbol rate is the same as the data rate.

4. The system of claim 3 wherein first data rate breakpoint is 256 kbps.

5. The system of claim 1 wherein for data rates between a first data rate breakpoint and a second data rate breakpoint, the symbol rate is one half the data rate.

6. The system of claim 5 wherein the first data rate breakpoint is 256 kbps and the second data rate breakpoint is 512 kbps.

7. The system of claim 1 wherein in for data rates above a second data rate breakpoint, the symbol rate is one third the data rate.

8. The system of claim 7 wherein the second data rate breakpoint is 512 kbps.

9. The system of claim 1 wherein the splitter is a distributed splitter and the SHDSL transceiver is further adapted to execute a fast retrain algorithm in response to disruptions.

10. A device adapted for use in an SHDSL over voice communication system configured with a splitter, the splitter including a high frequency filter for filtering SHDSL data and a low frequency filter for filtering voice data thereby allowing the system to operatively couple with an SHDSL over voice transmission line, the device comprising:
an encoder adapted to convert a bit stream to a sequence of K-bit parallel words, wherein K decreases in value with increasing data rates so as to limit effects caused by the splitter on usable SHDSL band; and
a precoder having a modulo operator adapted to decrease low frequency spectral content of a transmit signal by moving the transmit signal's low frequency spectral content toward an upper end of available PSD range.

11. The device of claim 10 wherein each parallel word has a least significant bit that is encoded using a convolutional encoding algorithm thereby producing encoded words of K+1 bits, the device further comprising:
a mapper adapted to receive the K+1-bit words generated by the encoder, and to map each of the words to a corresponding one of the 2^{K+1} levels of a signal constellation.

12. The device of claim 10 wherein for data rates up to a first data rate breakpoint, the value of K provides a symbol rate that is the same as the data rate.

13. The device of claim 12 wherein first data rate breakpoint is 256 kbps.

14. The device of claim 10 wherein for data rates between a first data rate breakpoint and a second data rate breakpoint, the value of K provides a symbol rate that is one half the data rate.

15. The device of claim 14 wherein the first data rate breakpoint is 256 kbps and the second data rate breakpoint is 512 kbps.

16. The device of claim 10 wherein in for data rates above a second data rate breakpoint, the value of K provides a symbol rate that is one third the data rate.

17. The device of claim 16 wherein the second data rate breakpoint is 512 kbps.

18. The device of claim 10 wherein the splitter is a distributed splitter and the SHDSL transceiver is further adapted to execute a fast retrain algorithm in response to disruptions.

19. A device adapted for use in an SHDSL over voice communication system configured with a splitter, the splitter including a high frequency filter for filtering SHDSL data and a low frequency filter for filtering voice data thereby allowing the system to operatively couple with an SHDSL over voice transmission line, the device comprising:
a complementary modulo operator adapted to recover original symbols from an expanded symbol set produced by a transmitting node precoder, the precoder having a modulo operator adapted to decrease low frequency spectral content of a transmit signal by moving the transmit signal's low frequency spectral content toward an upper end of available PSD range; and
a decoder operatively coupled to the complementary modulo operator, and adapted to convert a sequence of K-bit parallel words associated with the recovered symbols to a bit stream, wherein K decreases in value with increasing data rates so as to limit effects caused by the splitter on usable SHDSL band.

20. A method for transmitting signals in an SHDSL over voice communication system configured with a splitter, the method comprising:
converting a bit stream to a sequence of K-bit parallel words, wherein K decreases in value with increasing data rates so as to limit effects caused by the splitter usable SHDSL band; and
decreasing low frequency spectral content of a transmit signal by moving the transmit signal's low frequency spectral content toward an upper end of available PSD range.

21. A method for receiving signals in an SHDSL over voice communication system configured with a splitter, the method comprising:
recovering original symbols from an expanded symbol set produced by a transmitting node precoder, the precoder having a modulo operator adapted to decrease low frequency spectral content of a transmit signal by moving the transmit signal's frequency content toward an upper end of available PSD range; and
converting a sequence of K-bit parallel words associated with the recovered symbols to a bit stream, wherein K decreases in value with increasing data rates so as to limit effects caused by the splitter on usable SHDSL band.

22. A computer program product, stored on a computer readable medium, for use in an SHDSL over voice communication system configured with a splitter that allows the system to operatively couple with an SHDSL over voice transmission line, the computer program product comprising
an encoder module adapted to convert a bit stream to a sequence of K-bit parallel words, wherein K decreases in value with increasing data rates so as to limit effects caused by the splitter on usable SHDSL band; and
a precoder module having a modulo operator adapted to decrease low frequency spectral content of a transmit signal by moving the transmit signal's low frequency spectral content toward an upper end of available PSD range.

23. A computer program product, stored on a computer readable medium, for use in an SHDSL over voice communication system configured with a splitter that allows the system to operatively couple with an SHDSL over voice transmission line, the computer program product comprising
a complementary modulo operator module adapted to recover original symbols from an expanded symbol set produced by a transmitting node precoder, the precoder having a modulo operator adapted to decrease low frequency spectral content of a transmit signal by moving the transmit signal's low frequency spectral content toward an upper end of available PSD range; and
a decoder module operatively coupled to the complementary modulo operator, and adapted to convert a sequence of K-bit parallel words associated with the recovered symbols to a bit stream, wherein K decreases in value with increasing data rates so as to limit effects caused by the splitter on usable SHDSL band.
